(19) United States
(12) Patent Application Publication
(10) Pub. No.: US 2006/0151590 A1
(43) Pub. Date: Jul. 13, 2006

(54) Boring device

(75) Inventors: Toshiyuki Majima, Kaga-shi (JP); Kazuo Nishimura, Kaga-shi (JP)

Correspondence Address: WENDEROTH, LIND & PONACK, L.L.P., 2033 K STREET N. W., SUITE 800, WASHINGTON, DC, 20006-1021, US

(73) Assignee: DAIDO KOGYO Co., Ltd.

(21) Appl. No.: 10/532,135

(22) PCT Filed: Oct. 21, 2003
(86) PCT No.: PCT/JP03/13412

§ 371 Date: Oct. 6, 2005

(30) Foreign Application Priority Data
Oct. 21, 2002 (JP) 2002-306361

(51) Int. Cl. G06K 1/02

(52) U.S. Cl. 234/38

(57) ABSTRACT

There is provided a punching unit arranged so that a plurality of punches (52a through 52c and 53 or 89a through 89d) is grouped into a first group having a predetermined number of punches and into a second group containing any one of the punches in the first group and having a less number of punches and so as to produce a punching state of the predetermined number of punches by reciprocating a reciprocating member (35 or 75) within a first movable range and by vertically moving the punches of the first group through an intermediary of cams and followers (62 or 25) corresponding to the first group and another punching state of the less number of punches by reciprocating the reciprocating member (35 or 75) within a second movable range and by vertically moving the punches of the second group through an intermediary of cams and followers corresponding to the second group. This arrangement allows the number of punches and dies to be reduced as compared to the prior art unit and the structure of the unit to be simplified with less number of parts.

### TECHNICAL FIELD

The present invention relates to a punching unit for punching holes in a sheet type member by engaging punches with corresponding dies and more specifically to a punching unit which may be most suitably attached to a main unit of an image forming apparatus, such as a copying machine, a printer, a facsimile and a multifunction machine of those machines, or to a printing machine.

### BACKGROUND ART

Hitherto, as a punching unit of the sort described above, there have been known a dedicated type punching unit dedicated for punching two holes, three holes or four holes and a switching type punching unit arranged so as to be able to commonly use punches in punching two holes and three holes or two holes and four holes. As the switching type punching unit, there is known a sliding-cam type punching unit wherein a stroke range of a cam is divided into two stages so as to be able to punch two holes in a certain stroke range and to punch three holes in another stroke range as disclosed in Japanese Patent Laid-Open No. 2001-198889.

### DISCLOSURE OF INVENTION

However, such sliding-cam type punching unit requires many parts because it requires punches and dies each equal to a total number of holes to be punched, e.g., five each punches and dies in the switching type punching unit for punching two and three holes. Accordingly, it has been desired to realize a punching unit whose punches and dies may be reduced and whose structure may be simplified with less number of parts, while having the function of punching different numbers of holes.

It is therefore an object of the invention to solve the aforementioned problems by providing a punching unit whose punches and dies are reduced as compared to those of the prior art punching unit and whose structure is simplified with less number of parts.

According to one aspect of the invention, a punching unit (30 or 60) is provided with a plurality of punches (52a through 53c and 53 or 89a through 89d) and dies (54 or 29) for punching holes in a sheet type member, a reciprocating member (35 or 75) capable of reciprocating in the direction orthogonal to moving directions of the punches, and a plurality of cams (44, 84 and 94, or 11 through 14) and followers (62 or 25) that engage with the cams, interposed between the reciprocating member (35 or 75) and the plurality of punches, for converting the reciprocating movement of the reciprocating member (35 or 75) into a vertical movement of the punches to punching and non-punching positions; wherein:

the plurality of punches are grouped into a first group composed of a predetermined number of punches and into a second group containing any one of the punches in the first group and having a less number of punches than the predetermined number of punches in the first group; and

a punching state of the predetermined number of punches is produced by reciprocating the reciprocating member (35 or 75) within a first movable range and by vertically moving the punches of the first group through an intermediary of the cams and followers corresponding to the punches of the first group and a punching state of the less number of punches than the predetermined number of punches is produced by reciprocating the reciprocating member (35 or 75) within a second movable range and by vertically moving the punches of the second group through an intermediary of the cams and followers corresponding to the punches of the second group.

Accordingly, since the punching unit is capable of producing the punching state of the predetermined number of holes by reciprocating the reciprocating member (35 or 75) within the first movable range and by vertically moving the punches of the first group through the intermediary of the cams and followers corresponding to the punches of the first group and is capable of producing the punching state of the less holes than the predetermined number by reciprocating the reciprocating member (35 or 75) within the second movable range and by vertically moving the punches of the second group through the intermediary of the cams and followers corresponding to the second group, and since any one of the punches of the first group is contained also in the punches of the second group and the number of punches of the second group is fewer than that of the first group, each punch in the first and second groups may be selectively put into operation corresponding to the move of the reciprocating member (35 or 75) and it becomes possible to lessen a total number of punches used in the different punching processes to be less than a total number of punches of the first and second groups, while having the functions of two units that carry out the processes of punching different number of holes. Thus, the number of punches and corresponding dies may be reduced as compared to those of the prior art unit. Still more, the number of parts may be reduced, the structure of the unit may be simplified and its cost may be lowered. Accordingly, when this punching unit is mounted to an image forming apparatus such as a copying machine, it can contribute to multi-functioning of the apparatus.

Preferably, the first movable range is a range in which the reciprocating member (35) reaches in advancing in one direction from a home position with respect to the main frame and the second movable range is a range in which the reciprocating member (35) reaches in advancing in the other direction from the home position.

Accordingly, the reciprocating member (35) may reach to the first or second movable range readily and reliably just by moving in one direction or in the other direction from the home position and hence the control may be simplified.

Preferably, first and second neutral positions are provided on the opposite side from the home position, respectively, in the first and second movable ranges provided at the positions interposing the home position therebetween; and

the reciprocating member (35) vertically moves the plurality of punches as the first or second group in reciprocating in the first and second movable ranges, respectively.

Accordingly, the mechanism for vertically moving the plurality of punches reliably as the first or second group just by reciprocating the reciprocating member (35) in the first or second movable range may be realized.

Preferably, the first group is composed of three punches (52a, 52b and 52c) arrayed at a predetermined pitch and the common punch (52b), that may be commonly used also in the second group, is positioned at the center of the three punches (52a, 52b and 52c) in the first group; and

the second group is composed of the common punch (52b) and a punch (53) dedicated for punching two holes and disposed between the punch (52c) positioned at one end among the three punches (52a, 52b and 52c) of the first group and the common punch (52b).

Accordingly, since this arrangement produces the three-hole punching state in which the common punch (52b) at the center of the first group is positioned at the center and the two-hole punching state in which its center is positioned at the intermediate position between the common punch (52b) and the punch (53) dedicated for punching two holes, the two-hole and three-hole punching processes may be freely carried out to the member to be punched by only four punches (52a through 52c and 53) and dies (54) in total by using the common punch (52b) at the center of the three-hole punches (52a, 52b and 52c) also for punching two holes by shifting the respective centers in correspondence to the respective processes. Thus, it becomes possible to readily switch the process for punching three holes at a certain pitch in the member to be punched and the process for punching two holes at a different pitch.

Preferably, the cam (84) corresponding to the common punch (52b) is provided with, continuously via a linear portion (87b), a first V-shaped portion (85 or 86) capable of moving the common punch (52b) from the non-punching position to the punching position when the reciprocating member (35) moves in one direction and a second v-shaped portion (85 or 86) capable of moving the common punch (52b) from the non-punching position to the punching position when the reciprocating member (35) moves in the other direction.

Accordingly, since the cam (84) corresponding to the common punch (52b) is provided with, continuously via the linear portion (87b), the first V-shaped portion capable of moving the common punch (52b) when the reciprocating member (35) moves in one direction and the second V-shaped portion capable of moving it when the reciprocating member (35) moves in the other direction, the structure for freely moving the common punch (52b) as the punch of the first group or the second group may be realized even though it is simple.

Preferably, the first movable range is a range to which the reciprocating member (75) reaches in advancing by one step in one direction from a home position with respect to the main frame and the second movable range is a range to which the reciprocating member (75) reaches in advancing further by one step in one direction from the first movable range.

Accordingly, since the reciprocating member (75) may readily and reliably reach to the first or second movable range just by advancing by one step in one direction from the home position or by advancing further by one step in one direction from the first movable range, the control may be simplified.

Preferably, first and second neutral positions are provided in order from the home position in the first and second movable ranges sequentially provided in one direction from the home position; and

the reciprocating member (75) vertically moves the plurality of punches (89a through 89d) as the first or second group in reciprocating respectively in the first and second movable ranges.

Accordingly, the plurality of punches (89a through 89d) may be vertically moved reliably as the first or second group just by reciprocating the reciprocating member (75) within the first or second movable range.

Preferably, the first group is composed of three or more punches (89a through 89d) arrayed at a predetermined pitch and the second group is composed of at least two punches (89b and 89c) among the punches in the first group.

Accordingly, because the first group is composed of the four or more punches, i.e., the even number of punches (89a through 89d), and the second group is composed of the two center punches (89b and 89c) among the punches (89a through 89d) of the first group, the four- and two-hole punching processes may be adequately and freely carried out on the sheet P without shifting, in correspondence to each process, the center of each punching state of the four-punching state which is carried out centering on the center part of the four punches (89a through 89d), i.e., the intermediate position between the punches (89b and 89c), of the first group and of the two-hole punching state which is carried out centering on the intermediate position between the two center punches (89b and 89c) of the first group.

Preferably, the punching unit (60) is provided further with move restricting means (23) for restricting the reciprocating member (75) from moving to the movable range on the opposite side in using the reciprocating member (75) within the first or second movable range.

Accordingly, it becomes possible to reduce a number of sensors for detecting the move of the cam plate (75) by the very simple arrangement of just restricting the move of the cam plate (75) to the movable range on the opposite side by the move restricting means (23). That is, when the punching unit (60) is mounted to a main unit of a copying machine or the like, a control is made so as to be able to use only the group actually used often based on data detected by the sensors for detecting the move of the reciprocating member (75) to the group of the opposite side. For instance, when the control is reset after when a supply of electric power is started again from a condition of system-down such as a power failure, the control of shifting the reciprocating member (75) to the group used before the power failure is normally carried out based on the result detected by the sensor. Accordingly, although the sensor (78) is essential, the present invention enables the relatively expensive sensor (78) to be eliminated and the cost to be cut because it restricts the very move of the reciprocating member (75) to the opposite side by the move restricting means (23) and by omitting the sensor (78).

Preferably, the move restricting means (23) is a stopper for blocking the move of the reciprocating member (75) at a predetermined position with respect to the main frame.

Accordingly, since the move restricting means (23) for stopping the move of the reciprocating member (75) at the predetermined position with respect to the main frame may be arranged by the stopper, the move restricting means (23) may be constructed very simply.

Additional objects and advantages of the invention will be apparent from the following detailed description of preferred embodiments thereof, which are best understood with reference to the accompanying drawings.

### BRIEF DESCRIPTION OF THE DRAWINGS

FIG. 1 is a partially broken front view of a punching unit according to a first embodiment of the invention;

FIG. 2 is a plan view of the punching unit in FIG. 1;

FIG. 3 is a section view of the punching unit taken along a line A-A in FIG. 1;

FIG. 4 is a section view of the punching unit taken along a line B-B in FIG. 1;

FIGS. 5A through 5C are section views of the punching unit for explaining operations of the punching unit of the present embodiment, wherein FIG. 5A shows a three-hole punching state for punching three holes by punches of a first group, FIG. 5B shows an initial state, and FIG. 5C shows a two-hole punching state for punching two holes by punches of a second group;

FIG. 6 is a partially broken front view of a punching unit according to a second embodiment of the invention;

FIG. 7 is a plan view of the punching unit in FIG. 6;

FIG. 8 is a bottom view of the punching unit in FIG. 6;

FIG. 9 is a side view of the punching unit taken along a line E-E in FIG. 6;

FIG. 10 is a side section view of the punching unit taken along a line F-F in FIG. 6; and

FIG. 11 is a partially enlarged front view of a movable range detecting sensor, a rack and others in FIG. 6.

### BEST MODES FOR CARRYING OUT THE INVENTION

### First Embodiment

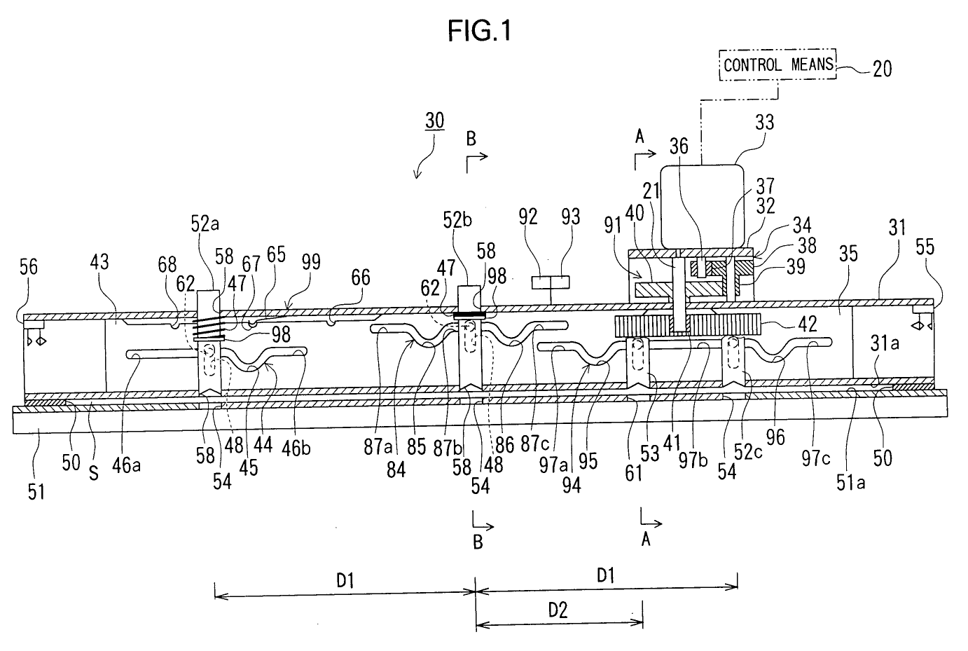

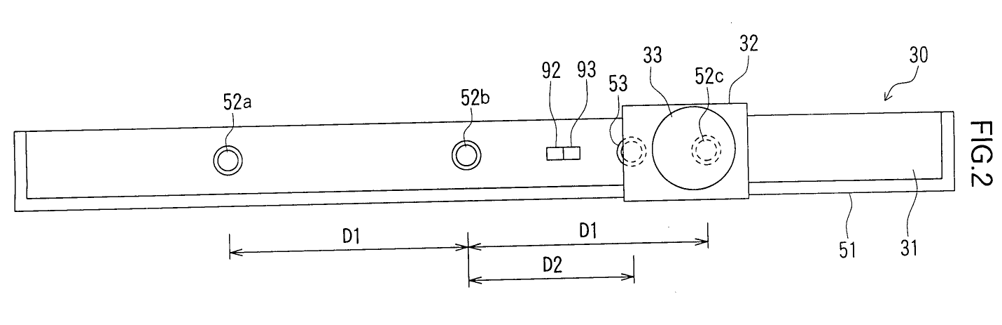

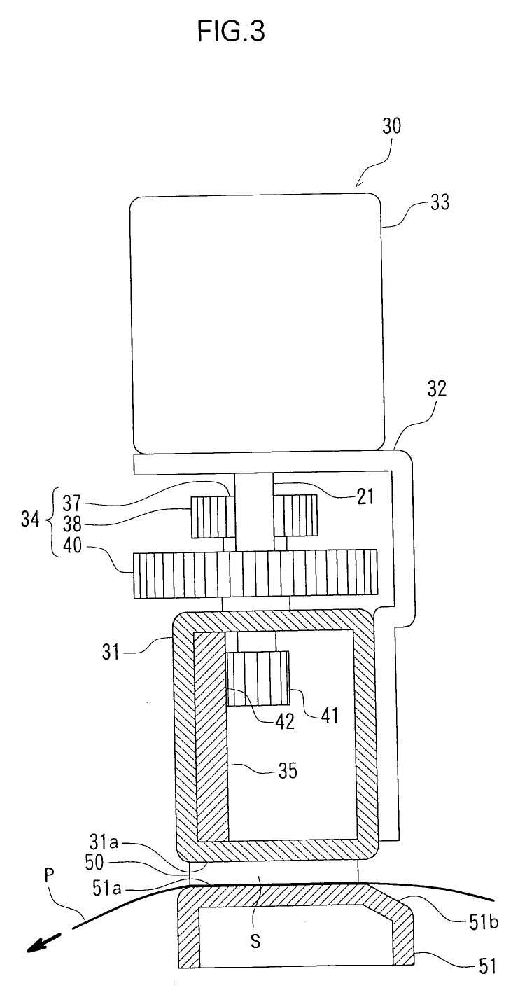

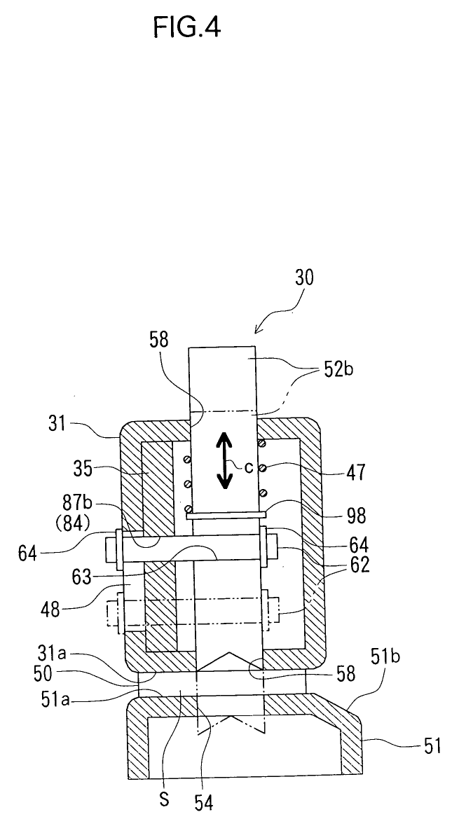

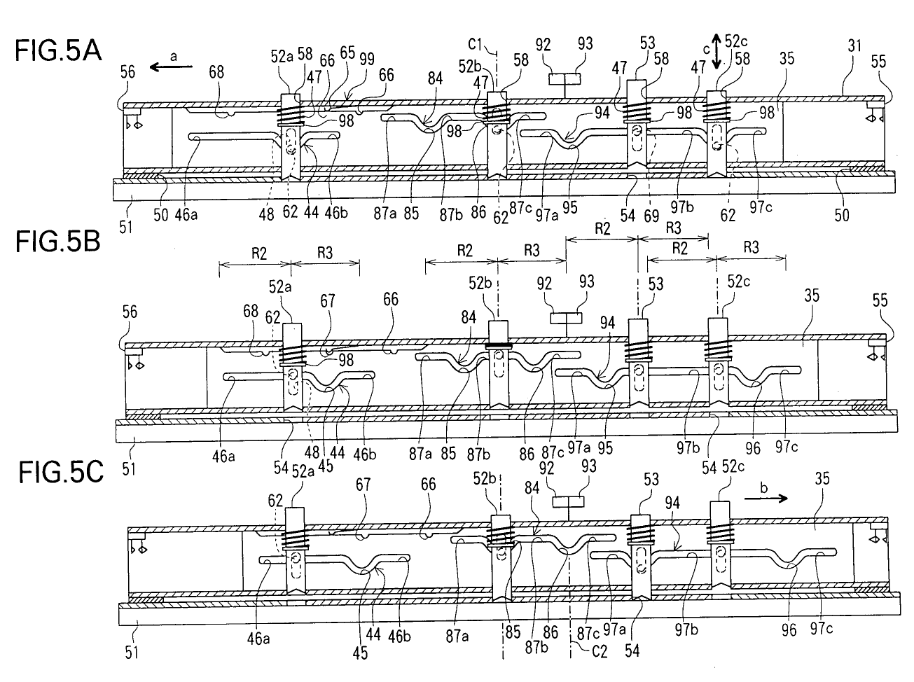

A first embodiment of an inventive punching unit will be explained below with reference to the drawings. FIG. 1 is a partially broken front view of the punching unit according to the first embodiment of the invention, FIG. 2 is a plan view of the punching unit in FIG. 1, FIG. 3 is a section view of the punching unit taken along a line A-A in FIG. 1, FIG. 4 is a section view of the punching unit taken along a line B-B in FIG. 1 and FIGS. 5A through 5C are section views of the punching unit for explaining operations of the punching unit of the present embodiment.

As shown in FIGS. 1 and 2, the punching unit 30 of the present embodiment has a rectangle-tublar main frame 31, on which a motor 33 is disposed through an intermediary of a bracket 32. The motor 33 is linked to a lengthy cam plate (reciprocating member) 35 through an intermediary of a speed reducing gear mechanism 34 and functions as a driving source for moving the cam plate 35 in the lateral direction in FIG. 1. The punching unit 30 is also provided with control means 20 for calculating a number of revolution, directions of rotation and others of the motor 33 upon receiving detecting signals from the motor 33, punch detecting sensors 92 and 93 and cam plate detecting sensors 55 and 56 described later and for controlling the motor 33 by outputting a corresponding driving signal.

As shown in FIG. 1, the speed reducing gear mechanism 34 has a driving gear 37 fixed to an output shaft 36 of the motor 33 that penetrates through the bracket 32, a large intermediary gear 38 and a small intermediary gear 39 which are formed in a body and are rotatably supported by the bracket 32, a follower gear 40 which is fixed to a pivot 21 rotatably supported by the bracket 32 and whose diameter is larger than that of the intermediary gear 39, a pinion 41 fixed at the edge of the pivot 21 within the main frame 31 and a rack 42 engaging with the pinion 41 and provided along the extension of the cam plate 35. It is noted that in FIG. 1, the upper part of punches 53 and 52c, which are actually positioned in front of the rack 42 in the figure, is omitted in the figure for convenience.

The cam plate 35 is disposed so as to be able to reciprocate in the lateral direction in FIG. 1 along the inner face of the main frame 31 while receiving a rotational force of the pinion 41 via the rack 42. A part of the upper edge of the cam plate 35 in the vicinity of the left end thereof is slightly cut away and a convex portion 43 is formed at the left end of the upper edge. The convex portion 43 reduces a contact area of the cam plate 35 with the main frame 31, so that sliding resistance decreases and the cam plate 35 slides smoothly.

Three notches 66, 67 and 68 are formed at predetermined intervals in the cut-away portion of the upper edge of the cam plate 35 in the vicinity of the left end thereof and a resilient positioning plate 65 is provided at the inner face of the main frame 31 above the cut-away portion while being biased downward. By engaging with the positioning plate 65, the center notch 67 anchors the cam plate 35 to the center initial position (see FIG. 5B). Similarly, by engaging with the positioning plate 65, the right notch 66 anchors the cam plate 35 to the left end position and the left notch 68 anchors the cam plate 35 to the right end position. The positioning plate 65 and the notches 66, 67 and 68 compose a cam plate positioning mechanism 99. The speed reducing gear mechanism 34 and others compose driving means 91 for converting the rotational force of the motor 33 to linear reciprocating force for reciprocating the cam plate 35 to vertically move punches 52a, 52b, 53 and 52c described later.

The cam plate 35 is provided with three cams 44, 84 and 94 formed in order from the left side of the figure. The cams 44 and 94 are formed so that their level is equal below the center of the cam plate 35 in the vertical direction, i.e., in the direction orthogonal to the longitudinal direction thereof. The cam 84 is positioned above the center of the cam plate 35 in the vertical direction and is formed so that a third linear portion 87c overlaps longitudinally with a first linear portion 97a of the cam 94.

The cams 44, 84 and 94 are formed respectively so as to penetrate from the front to the back of the cam plate 35 along the longitudinal direction thereof. The cam 44 has a first linear portion 46a formed so as to extend by a predetermined width in the longitudinal direction of the cam plate 35 on the level of center of the cam plate 35, a V-shaped portion 45 formed so as to gradually descend at a predetermined angle from the right end of the fist linear portion 46a and then to gradually ascend from the lowest point (bottom) at a predetermined angle and a second linear portion 46b formed so as to extend by a predetermined width from the right end of the V-shaped portion 45 in the longitudinal direction on the same level with the first linear portion 46a.

The cam 84 has a first linear portion 87a formed so as to extend by a predetermined width in the longitudinal direction of the cam plate 35 on the upper level of the cam plate 35, a V-shaped portion 85 formed so as to gradually descend at the predetermined angle from the right end of the fist linear portion 87a and then to gradually ascend from the bottom at the predetermined angle, a second linear portion 87b formed so as to extend by a predetermined width from the right end of the V-shaped portion 85 in the longitudinal direction on the same level with the first linear portion 87a, a V-shaped portion 86 formed so as to gradually descend at the predetermined angle from the right end of the second linear portion 87b and then to gradually ascend from the bottom at the predetermined angle, and a third linear portion 87c formed so as to extend by a predetermined width from the right end of the V-shaped portion 86 in the longitudinal direction on the same level with the first and second linear portions 87a and 87b.

The cam 94 has a first linear portion 97a formed so as to extend by a predetermined width in the longitudinal direction of the cam plate 35 on the level of center of the cam plate 35, a V-shaped portion 95 formed so as to gradually descend at the predetermined angle from the right end of the fist linear portion 97a and then to gradually ascend from the bottom at the predetermined angle, a second linear portion 97b formed so as to extend by a predetermined width from the right end of the V-shaped portion 95 in the longitudinal direction on the same level with the first linear portion 97a, a V-shaped portion 96 formed so as to gradually descend at the predetermined angle from the right end of the second linear portion 97b and then to gradually ascend from the bottom at the predetermined angle, and a third linear portion 97c formed so as to extend by a predetermined width from the right end of the V-shaped portion 96 in the longitudinal direction on the same level with the first and second linear portions 97a and 97b.

The punching unit 30 has the punches 52a, 52b and 52c, for use in punching three holes, which are supported movably in the direction orthogonal to the longitudinal direction at intervals of a predetermined distance Dl in the longitudinal direction of the main frame 31 (cam plate 35). The punching unit 30 also has a punch 53 dedicated for use in punching two holes and supported movably in the direction orthogonal to the longitudinal direction between the punches 52b and 52c apart from the punch 52b by a distance D2 that is shorter than the distance Dl. The punch 52b is used also in punching two holes as described later.

These punches 52a, 52b, 53 and 52c as well as the cams 44, 84 and 94 are arranged so as to have a predetermined positional relationship as described later. It is noted that pins 62, which are supported respectively by the punches 52a, 52b, 53 and 52c, are slidably inserted through the cams 44, 84 and 94.

That is, in the initial state in which the cam plate 35 is positioned at the center part of the main frame 31 as shown in FIGS. 1 and 5B, the pin 62 of the punch 52a is positioned in the first linear portion 46a near the V-shaped portion 45, the pin 62 of the punch 52b is positioned in the center part of the second linear portion 87b, the pin 62 of the punch 53 is positioned in the second linear portion 97b near the v-shaped portion 95, and the pin 62 of the punch 52c is positioned in the second linear portion 97b near the V-shaped portion 96.

Still more, in a three-hole punching state for punching three holes as shown in FIG. 5A, the pins 62 of the punches 52a, 52b and 52c are positioned in the V-shaped portion 45 of the cam 44, in the V-shaped portion 86 of the cam 84 and in the V-shaped portion 96 of the cam 94, respectively, and the pins 62 of the punch 53 dedicated for punching two holes is positioned in the center part of the second linear portion 97b of the cam 94.

Further, in a two-hole punching state for punching two holes as shown in FIG. 5C, the pins 62 of the punches 52b and 53 are positioned in the V-shaped portion 85 of the cam 84 and in the V-shaped portion 96 of the cam 94, respectively, and the pins 62 of the punches 52a and 52c dedicated for punching three holes are positioned in the left end of the first linear portion 46a of the cam 44 and in the center part of the second linear portion 97b of the cam 94, respectively.

In order to realize the initial state, the three-hole punching state and the two-hole punching state described above, the cams 44, 84 and 94 have the following positional relationship from each other.

That is, as shown in FIGS. 1, 2 and 5, they are arranged so that the pitch (Dl) of the three-hole punches 52a, 52b and 52c is equal to the pitch of the bottoms of the V-shaped portion 45, 86 and 96 corresponding thereto. Still more, they are set so that the length of the second linear portion 46b of the cam 44, the first linear portion 87a, the second linear portion 87b and the third linear portion 87c of the cam 84, and the first linear portion 97a and the third linear portion 97c of the cam 94 are equal from each other, and so that the first linear portion 97a of the cam 94 overlaps with the third linear portion 87c of the cam 84.

Further, the second linear portion 97b of the cam 94 is set so as to have a length slightly longer than a distance between the punches 53 and 52c so as to be able to keep the both neighboring punches 53 and 52c at the highest position (non-punching position) in the initial state described above, to forward the punch 52c to the V-shaped portion 96 and to keep the punch 53 at the highest position in the three-hole punching state described above, and to forward the punch 53 to the V-shaped portion 95 and to keep the punch 52c at the highest position in the two-hole punching state described above.

The cam 44 is set so that the first linear portion 46a of the cam 44 has a length equal to that of the second linear portion 97b of the cam 94 so as to be able to keep the punch 52a at the highest position until when the two-hole punching state in FIG. 5C passes from the initial state in FIG. 5B.

Meanwhile, as shown in FIGS. 1, 3 and 4, a leg 51 is attached to a lower face 31a of the main frame 31 through an intermediary of spacers 50. The spacer 50 is provided to form a gap S that permits sheets (member to be punched) P to pass between the lower face 31a and an upper face 51a of the leg 50. A slope 51b for guiding the sheet P to the gap S is formed at the corner of the leg 51 as shown in FIG. 3.

As shown in FIG. 1, the main frame 31 is provided with eight punch-supporting holes 58 in total formed so as to penetrate through the upper and lower faces of the main frame 31. The punches 52a, 52b, 53 and 52c are slidably inserted through these punch-supporting holes 58, respectively. Four dies 54 are formed through the upper face 51a of the leg 51 so as to face to the punch-supporting holes 58 at the lower face of the main frame 31, respectively. An internal diameter of each die 54 is set to be almost equal to an outside diameter of the respective punches 52a, 52b, 53 and 52c to which the respective dies engage.

The punches 52a, 52b and 52c are arrayed at an equal pitch (Dl) and compose a first group for punching three holes in the sheet P. The punch 53 composes, together with the punch 52b (common punch) that is also used for punching three holes, a second group for punching two holes in the sheet P.

Then, as shown in FIGS. 1 and 4, the punch 52b for example is provided with a through hole 63 in the direction orthogonal to its moving direction (vertical direction in the figure) c. The through hole 63 supports the aforementioned pin (follower) 62 so that it penetrates through the hole 63 and the second linear portion 87b and protrudes toward a guide long hole 48 of the main frame 31. The guide long hole 48 is formed so as to penetrate through a side wall of the main frame 31 and so that it's longitudinal direction coincides with the vertical direction. Removable stop rings 64 are fitted to the both ends of the pin 62 so that the pin 62 will not come out of the through hole 63 of the punch 52b.

Still more, the punch 52b is provided with a spring 47 that biases the punch 52b toward the corresponding die 54. The spring 47 is interposed between the upper edge of the main frame 31 and a stop ring 98 fixed to the punch 52b. Although the spring 47 biases the punch 52b downward, the punch 52b will not come out of the main frame 31 because the pin 62 penetrates through the second linear portion 87b of the cam 84 and is held by that.

It is noted that the punch 52b indicated by a solid line in FIG. 4 shows the state in which it is positioned at the highest position and that indicated by a two-dotted line shows the state in which it is positioned at the lowest position (punching position) It is noted that although the supporting structure has been described centering on that of the punch 52b, the structures for supporting the other punches 52a, 53 and 52c are the same with that and an explanation thereof will be omitted here.

Further, as shown in FIG. 1, cam plate detecting sensors 55 and 56 for detecting that the cam plate 35 has reached to the right or left end are provided at the both ends of the movable range of the cam plate 35 within the main frame 31. Still more, a punch detecting sensor 92 for detecting the upper end of the punch 52b among the three-hole punches 52a, 52b and 52c and a punch detecting sensor 93 for detecting the upper end of the punch 53 among the two-hole punches 52b and 53 are provided on the upper face of the main frame 31.

In the punching unit 30 of the present embodiment having the structure described above, a range within which the cam plate 35 reaches when it is moved to the left as shown in FIG. 5A from the home position, i.e., the initial state in FIG. 5B, will be defined as a first movable range R3 and a range within which the cam plate 35 reaches when it is moved to the right as shown in FIG. 5C from the home position will be defined as a second movable range R2.

The three-hole punching state using the three-hole punches 52a, 52b and 52c as the first group is obtained by reciprocating the cam plate 35 within the first movable range R3 and the two-hole punching state using the two-hole punches 52b and 53 as the second group is obtained by reciprocating the cam plate 35 within the second movable range R2.

When the home position is denoted as N₂ and the position where all of the punches separate from the dies 54, thus producing the non-punching state beside the home position, is defined as a neutral position, a neutral position N₁ and a neutral position N₃ exist respectively on the opposite side from the home position N₂ with respect to an intermediate position described later where the punching state is produced in the first and second movable ranges R3 and R2. That is, with respect to the first and second movable ranges R3 and R2 interposing the home position N₂ therebetween, this state may be expressed as follows:
N₁←→three-hole punching state (R3)←N₂→two-hole punching state (R2)←→N₃

(Operation in Punching Three Holes)

In the initial state of the punching unit 30 in which the motor 33 is stopped, the positioning plate 65 of the cam plate positioning mechanism 99 engages with the notch 67 and the cam plate 35 is held at the center within the main frame 31 as shown in FIG. 1 (i.e., in FIG. 5B). At this time, the pin 62 of the punch 52a is positioned in the first linear portion 46a of the cam 44, the pin 62 of the punch 52b is positioned in the second linear portion 87b of the cam 84 and the pins 62 of the punches 53 and 52c are positioned in the second linear portion 97b of the cam 94, respectively. That is, all of the punches are kept at the highest positions.

When the sheet P is fed into the gap S between the main frame 31 and the leg 51 through an intermediary of sheet conveying means not shown and is positioned at a predetermined position in this initial state, a sensor not shown detects that the sheet P has been fed to the punching unit 30. Then, based on this detection, the control means 20 turns on the punching unit 30. It is assumed that a user has made a setting for punching three holes in advance by this point of time.

Then, the control means 20 drives the motor 33 to move the cam plate 35 so as to shift from the initial state in FIG. 5B to the three-hole punching state in FIG. 5A. Then, because the cam plate 35 starts to move to the left, the pin 62 of the punch 52a is guided from the first linear portion 46a to the bottom of the V-shaped portion 45, the pin 62 of the punch 52b is guided from the second linear portion 87b to the bottom of the V-shaped portion 86 and the pin 62 of the punch 52c is guided from the second linear portion 97b to the bottom of the V-shaped portion 96.

Thereby, the three-hole punches 52a, 52b and 52c drop to the lowest position, respectively, and engage with the dies 54 after punching holes in the sheet P as shown in FIG. 5A. In the same time, when the punch detecting sensor 92 detects that the punch 52b that is one of the three-hole punches is positioned at the lowest position, the control means 20 recognizes that three holes have been punched in the sheet P by the punches 52a, 52b and 52c of the first group. In this state, the cam plate 35 is positioned at the intermediate position of the first movable range R3 after moving from the home position N₂.

Then, in response to a signal from the control means 20, the motor 33 rotates and continues to move the cam plate 35 to the left, so that the cams 44, 84 and 94 lead the respective pins 62 to the second linear portion 46b, the third linear portion 87c and the third linear portion 97c and lift and keep the respective punches 52a, 52b and 52c at the highest position while keeping the punch 53 at the highest position by the second linear portion 97b of the cam 94. At this time, the cam plate 35 moves to the leftmost end and the positioning plate 65 of the cam plate positioning mechanism 99 engages with the notch 66, so that the cam plate 35 is held at that position. That is, the cam plate 35 is positioned at the final end of the first movable range R3 in this state.

At this point of time, the sheet P in which the three holes have been punched is pulled out of the gap S (see FIG. 3) and a new sheet P is fed to the gap S. When the motor 33 rotates reversely by a predetermined number of revolution in this state and when the cam plate 35 which is positioned at the left end moves to the right, i.e., when the cam plate 35 moves from the end of the first movable range R3 to the intermediate position, three holes are punched in the new sheet P by the three-hole punches 52a, 52b and 52c. When the cam plate 35 moves further to the right, i.e., when the cam plate 35 moves from the intermediate position of the first movable range R3 to the home position N₂, the pins 62 of the punches 52a, 52b and 52c are led to the first linear portion 46a, the second linear portion 87b and the second linear portion 97b, respectively. Then, the positioning plate 65 engages with the notch 67 and the cam plate 35 returns to the initial state in FIG. 5B.

Thus, the punching unit 30 is capable of repeatedly carrying out the operation of punching three holes by the punches 52a, 52b and 52c by reciprocating the cam plate 35 within the first movable range R3.

(Operation in Punching Two Holes)

When a sheet P is fed to the gap S between the main frame 31 and the leg 51 and stops at the predetermined position in the initial state in FIG. 5B in which the motor 33 is stopped, the control means 20 turns on the punching unit 30 based on the detection of the sensor not shown. It is assumed that the user has made a setting for punching two holes in advance by this point of time.

Then, the control means 20 drives the motor 33 to move the cam plate 35 so as to shift the state from the initial state in FIG. 5B to the two-hole punching state in FIG. 5C. Thereby, while the cam plate 35 starts to move to the right, the pins 62 of the punches 52a and 52c not used in punching two holes are held as they are at the highest position by the first linear portion 46a and the second linear portion 97b engaging therewith in the initial state. In contrary to that, the pin 62 of the punch 52b that is also used in punching three holes is guided from the second linear portion 87b to the bottom of the V-shaped portion 85 and the pin 62 of the punch 53 is guided from the second linear portion 97b to the bottom of the V-shaped portion 95.

Thereby, the two-hole punches 52b and 53 drop to the lowest position, respectively, and engage with the dies 54 after punching holes in the sheet P as shown in FIG. 5C. In the same time, when the punch detecting sensor 93 detects that the punch 53, which is one of the two-hole punches, is positioned at the lowest position, the control means 20 recognizes that two holes have been punched in the sheet P by the punches 52b and 53 of the second group. That is, the cam plate 355 is positioned in the intermediate position of the second movable range R2 after moving from the home position N₂.

Then, in response to the signal from the control means 20, the motor 33 rotates and continues to move the cam plate 35 further to the right, so that the cams 84 and 94 lead the respective pins 62 to the first linear portion 87a and the first linear portion 97a and lift and keep the respective punches 52b and 53 at the highest position while keeping the punches 52a and 52c at the highest position by holding the respective pins 62 in the first linear portion 46a and the second linear portion 97b of the cams 44 and 94. At this time, the cam plate 35 moves to the rightmost end and the positioning plate 65 of the cam plate positioning mechanism 99 engages with the notch 68, so that the cam plate 35 is held at that position. That is, the cam plate 35 is positioned at the final end of the second movable range R2.

At this point of time, the sheet P in which two holes have been punched is pulled out of the gap S (see FIG. 3) and a new sheet P is fed to the gap S. When the motor 33 rotates reversely by a predetermined number of revolution in this state and when the cam plate 35 that is positioned at the right end moves to the left, i.e., when the cam plate 35 moves from the final end of the second movable range R2 to the intermediate position N₂, two holes are punched in the new sheet P by the two-hole punches 52b and 53. When the cam plate 35 moves further to the left, i.e., when the cam plate 35 moves from the intermediate position of the second movable range R2 to the home position N₂, the pins 62 of the punches 52b and 53 are led to the second linear portion 87b and the second linear portion 97b, respectively. Then, the positioning plate 65 engages with the notch 67 and the cam plate 35 returns to the initial state in FIG. 5B.

Thus, the punching unit 30 is capable of repeatedly carrying out the operation of punching two holes by the punches 52b and 53 by reciprocating the cam plate 35 within the second movable range R2.

As described above, the punching unit 30 of the present embodiment is capable of punching three holes by moving the cam plate 35 to the left from the intermediate position and of punching two holes by moving the cam plate 35 to the right from the intermediate position. That is, it is possible to punch different numbers of holes at different positions of the sheet P by one unit.

At this time, because a position Cl corresponding to the position of the punch 52b becomes the center in punching three holes as shown in FIG. 5A and a position C2 corresponding to the position between the punches 52b and 53 becomes the center in punching two holes as shown in FIG. 5C, it is desirable to adopt the following methods in punching two and three holes in the sheet P having the same size.

For instance, the relative position of the whole punching unit 30 and a unit mounting section of a copying machine or the like mounting the punching unit 30 is shifted by position changing means not shown so that the center C2 coincides with the center Cl. Or, the position for feeding the sheet to the punching unit 30 by the sheet conveying means not shown in a copying machine or the like mounting the punching unit 30 is changed in punching two holes and in punching three holes. The punching process may be smoothly carried out while eliminating misalignment of centers in punching two and three holes by adequately adopting these methods.

While the punches 52a, 52b, 53 and 52c are provided, respectively, with the springs 47 for biasing the punches in the direction of approaching to the corresponding dies, the spring 47 adds a thrust force to each punch in punching a hole in the sheet P and also becomes a load in separating the respective punch from its corresponding die. It enables the load applied to the motor 33 required in moving the cam plate 35 to be almost uniformed and enables the process of continuously punching holes in the sheet P to be smoothly carried out.

Further, although the pins 62 have been provided on the side of the punches 52a, 52b, 53 and 52c, and the cams 44, 84 and 94 have been provided on the side of the cam plate 35, it is possible to reverse this relationship and to provide the cams on the side of the punches 52a, 52b, 53 and 52c and to provide the pins on the side of the cam plate 35.

As described above, the punching unit 30 of the present embodiment is capable of producing the three-hole punching state by reciprocating the cam plate 35 within the first movable range R3 to vertically move the punches 52a, 52b and 52c of the first group through the intermediary of the cams 44, 84 and 94 corresponding to the punches of the first group and the pins (followers) 62, and of producing the two-hole punching state in which holes to be punched is fewer than that of the first group by reciprocating the cam plate 35 within the second movable range R2 to vertically move the punches 52b and 53 of the second group. Further, because the second group includes the punch 53 that also belongs to the first group and the number of punches thereof is smaller than that of the first group, the total number of punches (four) used in the different punching processes may be lessened as compared to the total number of punches (five) of the first and second groups by selectively operating the respective punches of the first and second groups corresponding to the move of the cam plate 35 while having the function of two units carrying out the processes of punching the different number of holes. Thus, it allows the number of punches and of the corresponding dies to be reduced as compared to those of the prior art, the number of parts to be reduced and the structure of the unit to be simplified. It may also bring down the cost and will contribute to multi-functioning of an image forming apparatus such as a copying machine when it is mounted thereto.

Further, because it is capable of readily and steadily shifting to the first movable range R3 or to the second movable range R2 just by moving the cam plate 35 to the left or right from the home position N₂, its control may be simplified. Still more, it realizes the structure of vertically moving the punches 52a, 52b, 53 and 52c reliably as the first or second group just by reciprocating the cam plate 35 in the first movable range R3 or in the second movable range R2.

While the punching unit 30 produces the three-hole punching state centering on the common punch 52b positioned at the center of the first group and the two-hole punching state centering on the intermediate position between the common punch 52b and the punch 53 dedicated for punching two holes, it is freely capable of carrying out the two-hole and three-hole punching processes adequately to the sheet (to be punched) P just by the four punches (and dies) in total in which the common punch 52b at the center of the three-hole punches is used also in punching two holes by shifting the respective centers corresponding to the respective processes. That is, it becomes possible to readily switch the process of punching three holes in the sheet P with a certain pitch and the process of punching two holes with a pitch different thereto.

Still more, because the cam 84 corresponding to the common punch 52b is provided with the V-shaped portion 86 capable of operating the common punch 52b when the cam plate 35 moves to the left and the V-shaped portion 85 capable of operating the common punch 52b when the cam plate 35 moves to the right continuously via the second linear portion 87b, the structure that permits the common punch 52c to be freely operated as the first or second group may be realized even though its structure is so simplified.

### Second Embodiment

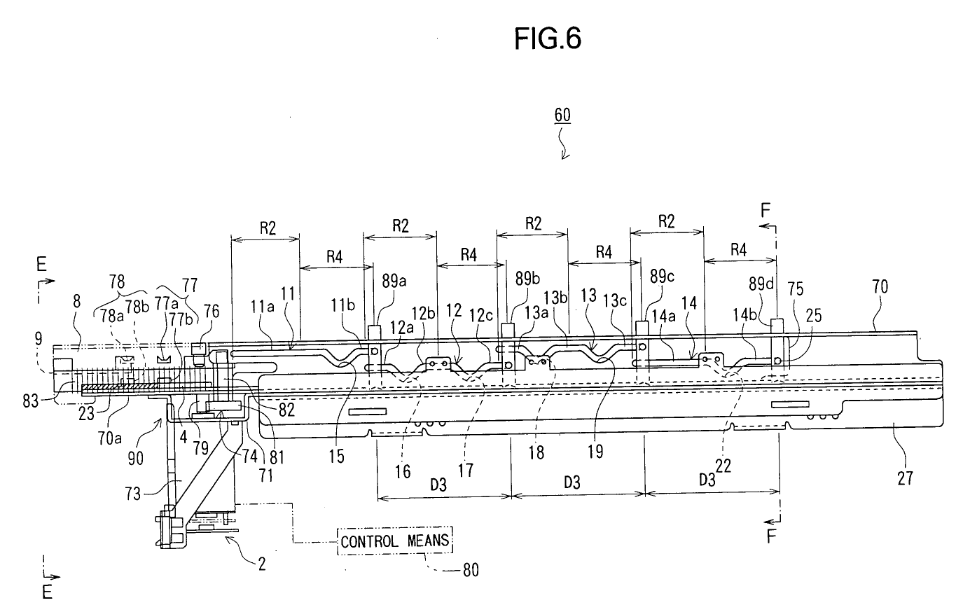

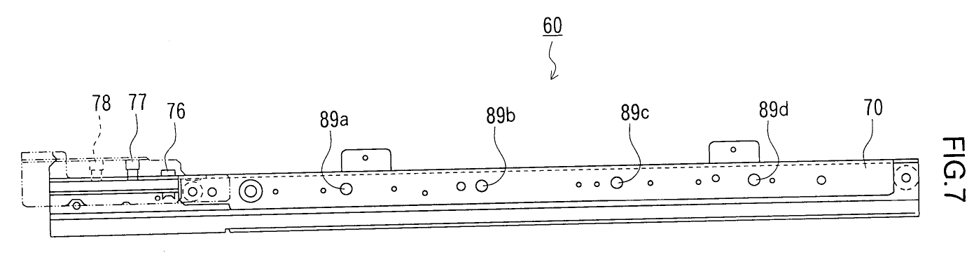

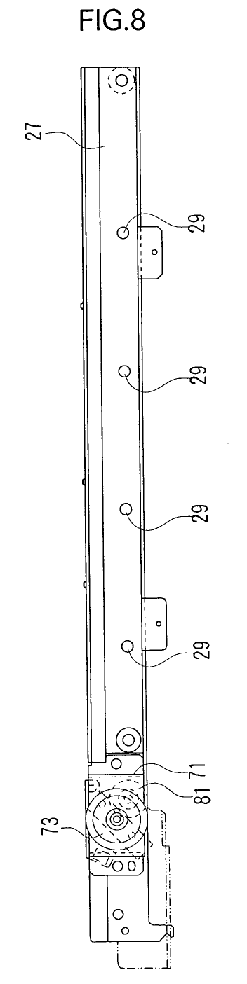

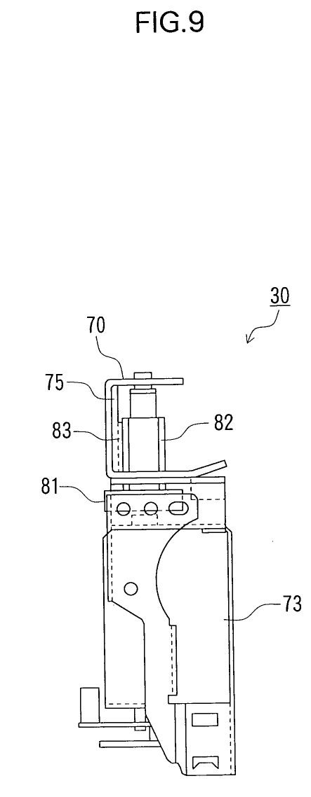

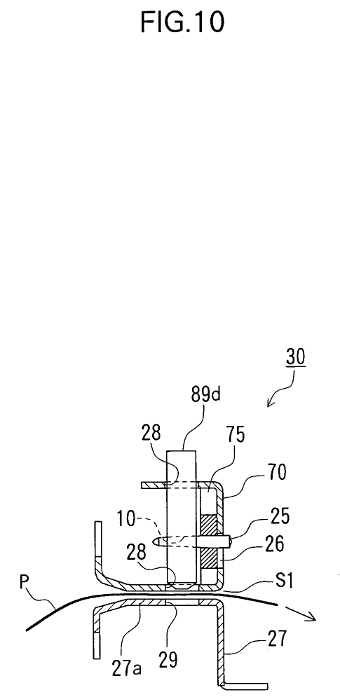

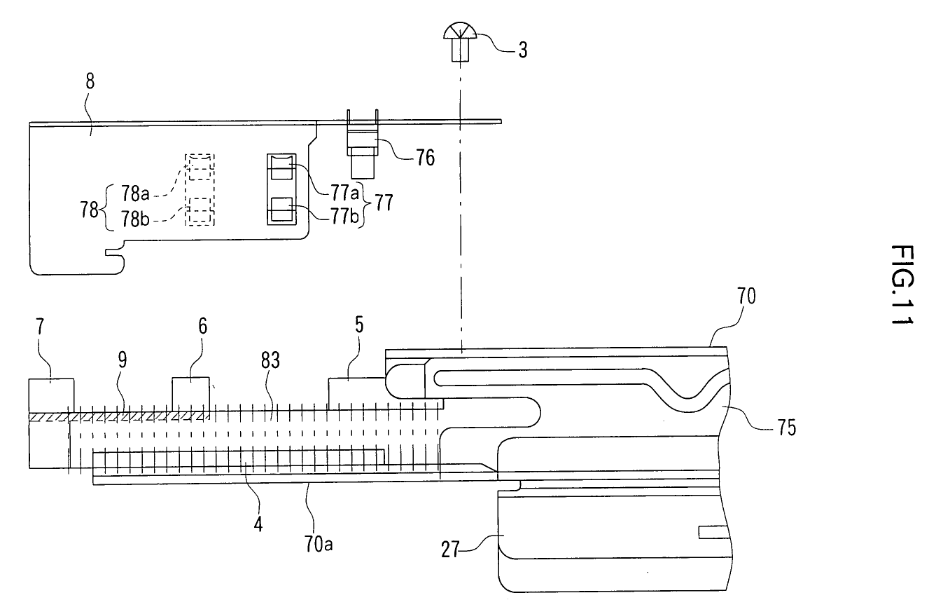

Next, a second embodiment of the inventive punching unit will be explained with reference to FIGS. 6 through 11. FIG. 6 is a partially broken front view of a punching unit according to a second embodiment of the invention, FIG. 7 is a plan view of the punching unit in FIG. 6, FIG. 8 is a bottom view of the punching unit in FIG. 6, FIG. 9 is a side view of the punching unit taken along a line E-E in FIG. 6, FIG. 10 is a side section view of the punching unit taken along a line F-F in FIG. 6 and FIG. 11 is a partially enlarged front view of a movable range detecting sensor, a rack and others in FIG. 6.

As shown in FIGS. 6 through 11, the punching unit 60 of the present embodiment is provided with a motor 73 on a main frame 70 through an intermediary of a bracket 71. The motor 73 is linked to a lengthy cam plate (reciprocating member) 75 through an intermediary of a speed reducing gear mechanism 74 and functions as a driving source for moving the cam plate 75 in the lateral direction. The punching unit 60 has control means 80 for controlling the motor 73 based on detecting signals received form movable range detecting sensors 76, 77 and 78. It is noted that an encoder 2 in FIG. 6 detects a number of revolution and others of the motor 73.

As shown also in FIG. 6, the speed reducing gear mechanism 74 has a driving gear 79 fixed to an output shaft of the motor 73 that penetrates through the bracket 71, large and small gears 81 and 82 formed in a body and rotatably supported by the bracket 71, and a rack 83 linked to the left end portion of the cam plate 75 while extending in the longitudinal direction of the cam plate 75 and engaging with the small gear 82.

The cam plate 75 is disposed so as to be able to reciprocate in the lateral direction of the figure along the inner face, i.e., in the rear side of FIG. 6, of the main frame 70 while receiving a rotational force of the small gear 82 through the intermediary of the rack 83. The speed reducing gear mechanism 74 and others compose driving means 90 for converting the rotational force of the motor 73 to a linear reciprocal force of the cam plate 755 for vertically moving punches 89a, 89b, 89c and 89d described later.

The cam plate 75 is provided with four cams 11, 12, 13 and 14 formed in order from the left side of the figure. The cams 12 and 14 are formed so that their level in the direction orthogonal to the longitudinal direction of the cam plate 75, i.e., in the vertical direction in the figure, is equal under the center thereof. The cams 11 and 13 are positioned above the center in the direction orthogonal to the longitudinal direction of the cam plate 75.

The cams 11 through 14 penetrate from the front to the back of the cam plate 75 along the longitudinal direction of the cam plate 75. The cam 11 has a first linear portion 11a formed so as to extend by a predetermined width in the longitudinal direction on the upper level of the cam plate 75 in the direction orthogonal to the longitudinal direction thereof, a V-shaped portion 15 that drops gradually at a predetermined angle from the right end of the first linear portion 11a and then rises gradually at the predetermined angle from the lowest part (bottom), and a second linear portion 11b extending from the right end of the V-shaped portion 15 by a predetermined width in the longitudinal direction on the same level with the first linear portion 11a.

The cam 12 has a first linear portion 12a formed so as to extend by a predetermined width in the longitudinal direction on the lower level of the cam plate 75 and so as to overlap by a predetermined length with the second linear portion 11b of the cam 11, a V-shaped portion 16 that drops from the right end of the first linear portion 12a gradually at the predetermined angle and then rises from the bottom gradually at the predetermined angle, a second linear portion 12b extending from the right end of the V-shaped portion 16 by a predetermined width in the longitudinal direction on the same level with the first linear portion 12a, a V-shaped portion 17 that drops from the right end of the second linear portion 12b gradually at the predetermined angle and then rises from the bottom gradually at the predetermined angle, and a third linear portion 12c extending from the right end of the V-shaped portion 17 by a predetermined width in the longitudinal direction on the same level with the first and second linear portions 12a and 12b.

The cam 13 has a first linear portion 13a formed so as to extend by a predetermined width in the longitudinal direction on the upper level of the cam plate 75 and so as to overlap by a predetermined length with the third linear portion 12c of the cam 12, a V-shaped portion 18 that drops from the right end of the first linear portion 13a gradually at the predetermined angle and then rises from the bottom gradually at the predetermined angle, a second linear portion 13b extending from the right end of the V-shaped portion 18 by a predetermined width in the longitudinal direction on the same level with the first linear portion 13a, a V-shaped portion 19 that drops from the right end of the second linear portion 13b gradually at the predetermined angle and then rises from the bottom gradually at the predetermined angle, and a third linear portion 13c extending from the right end of the V-shaped portion 19 by a predetermined width in the longitudinal direction on the same level with the linear portions 13a and 13b.

The cam 14 has a first linear portion 14a formed so as to extend by a predetermined width in the longitudinal direction on the lower level of the cam plate 75 and so as to overlap by a predetermined length with the third linear portion 13c of the cam 13, a V-shaped portion 22 that drops from the right end of the first linear portion 14a gradually at the predetermined angle and then rises from the bottom gradually at the predetermined angle, and a second linear portion 14b extending from the right end of the V-shaped portion 22 by a predetermined width in the longitudinal direction on the same level with the first linear portion 14a.

The punching unit 60 also has the punches 89a through 89d disposed in order in the longitudinal direction of the main frame 70 at a predetermined pitch (at intervals of a predetermined distance D3) while being supported movably in the direction orthogonal to the longitudinal direction. It is noted that even though not shown, there is provided a cam plate positioning mechanism for anchoring the cam plate 75 at predetermined positions also in the present embodiment similarly to the cam plate positioning mechanism 99 in the first embodiment.

While the movable range detecting sensor 76 comprises a light projecting element as shown in FIGS. 6 and 11, a light receiving element corresponding thereto is not shown in the figures. When the cam plate 75 moves laterally in the figure with respect to the main frame 70, dousing members 5, 6 and 7 sequentially block a light of the movable range detecting sensor 76. Then, the sensor 76 transmits a result detected at that time to the control means 80.

Based on the result of detection that the movable range detecting sensor 76 has been blocked by anyone of the dousing members 5, 6 and 7, the control means 80 detects the position of the cam plate 75 moving with respect to the main frame 70 and detects that the punches 89a through 89d are kept at the highest position (non-punching position). The control means 80 also detects that the punches 89a through 89d are positioned at the lowest position (punching position), i.e., that the punching operation is being conducted, based on the result of detection that the light of the movable range detecting sensor 76 is not blocked by anyone of the dousing members 5, 6 and 7,

The movable range detecting sensor 77 comprises a light projecting element 77a and a light receiving element 77b disposed so as to face to each other apart by a predetermined gap and the movable range detecting sensor 78 comprises a light projecting element 78a and a light receiving element 78b disposed so as to face to each other apart by a predetermined gap.

The light of the movable range detecting sensor 77 passes through or is blocked by a dousing plate 9 that moves between the light projecting element 77a and the light receiving element 77b when the cam plate 75 moves laterally in the figure with respect to the main frame 70 and the movable range detecting sensor 77 transmits a result detected at this time to the control means 80. Based on the result detected by the movable range detecting sensor 77, the control means 80 decides to which the cam plate 75 should be moved among the dousing member 5, 6 and 7 when the cam plate 75, i.e., the punches 89a through 89d, is started again after stopping at position other than the home position, i.e., at the position where the movable range detecting sensor 76 does not face to anyone of the dousing members 5, 6 and 7, due to a power failure or the like.

The light of the movable range detecting sensor 78 passes through or is blocked by the dousing plate 9 that moves between the light projecting element 78a and the light receiving element 78b when the cam plate 75 moves laterally in the figure with respect to the main frame 70 and the movable range detecting sensor 78 transmits a result detected at this time to the control means 80. Then, based on the result detected by the movable range detecting sensor 78, the control means 80 judges whether the cam plate 75, i.e., the punches 89a through 89d, is positioned in a first movable range R4 or in a second movable range R2. The movable range detecting sensor 78 avoids the cam plate 75 from moving to the movable range of the group not used then even if an abnormality occurs in the control due to a system down such as a power failure in using the punching unit 60 for punching four or two holes by using either the first group in the first movable range R4 or the second group in the second movable range R2.

Here, the punches 89a through 89d and the cams 11 through 14 described above are arranged so as to have the following predetermined positional relationship. It is noted that pins (followers) 25, supported by the respective punches 89a through 89d as described later, slidably engage with the respective cams 11 through 14.

That is, in the initial state shown in FIG. 6 in which the cam plate 75 is positioned at the left end of the main frame 70, the pin 25 of the punch 89a is positioned at the right end of the second linear portion 11b, the pin 25 of the punch 89b is positioned at the right end of the third linear portion 12c, the pin 25 of the punch 89c is positioned at the right end of the third linear portion 13c, and the pin 25 of the punch 89d is positioned at the right end of the second linear portion 14b. Thus, all of the punches 89a through 89d are positioned at the highest position (non-punching position). In this state, the control means 80 recognizes that the cam plate 75 is in the initial state based on the position of the cam plate 75 detected by the both movable range detecting sensors 76 and 77.

Then, in the four-hole punching state, the pin 25 of the punch 89a is positioned in the V-shaped portion 15, the pin 25 of the punch 89b is positioned in the V-shaped portion 17, the pin 25 of the punch 89c is positioned in the V-shaped portion 19, and the pin 25 of the punch 89d is positioned in the V-shaped portion 22. That is, in the four-hole punching state, the cam plate 75 shifts to the first movable range R4 and lowers the punch 89a at the V-shaped portion 15 of the cam 11, the punch 89b at the V-shaped portion 17, the punch 89c at the V-shaped portion 19 and the punch 89d at the V-shaped portion 22, respectively, to the lowest position (punching position). In this state, the control means 80 recognizes the four-hole punching state based on the result detected by the movable range detecting sensors 76 and 77.

In the two-hole punching state on the other hand, the pin 25 of the punch 89a is positioned in the first linear portion 11a, the pin 25 of the punch 89b is positioned in the V-shaped portion 16, the pin 25 of the punch 89c is positioned in the V-shaped portion 18, and the pin 25 of the punch 89d is positioned in the first linear portion 14a. That is, in the two-hole punching state, the cam plate 75 shifts to the second movable range R2 and lowers the punch 89b at the V-shaped portion 16 of the cam 12 and the punch 89c at the V-shaped portion 18, respectively, to the lowest position (punching position) while keeping the punch 89a at the first linear portion 11a of the cam 11 and the punch 89d at the first linear portion 14a to the highest position, respectively. In this state, the control means 80 recognizes the two-hole punching state based on the result detected by the movable range detecting sensors 76 and 77.

In order to realize the initial state, the four-hole punching state and the two-hole punching state described above, the cams 11 through 14 have the following positional relationship each other. That is, a pitch (D3) between the four-hole punches 89a, 89b, 89c and 89d is almost equal to a pitch between the bottoms of the corresponding V-shaped portions 15, 17, 19 and 22.

Still more, the second linear portion 11b of the cam 11, the third linear portion 12c of the cam 12, the third linear portion 13c of the cam 13 and the second linear portion 14b of the cam 14 are formed so as to become longer bit by bit in this order. Further, the second linear portion 12b of the cam 12 is formed to be slightly longer than the second linear portion 13b of the cam 13. This arrangement is made to lessen a load applied to the motor 73 in punching holes by moving the punches 89a through 89d of the first group or the punches 89b and 89c of the second group to the lowest position by shifting the timing for lowering the punches of the respective groups bit by bit.

The cams are set so that the second linear portion 11b of the cam 11 overlaps with the first linear portion 12a of the cam 12, the third linear portion 12c of the cam 12 overlaps with the first linear portion 13a of the cam 13, and the third linear portion 13c of the cam 13 overlaps with the first linear portion 14a of the cam 14.

Further, as shown in FIGS. 6 through 10, a leg 27 is attached to the lower face of the main frame 70 through an intermediary of spacers not shown. The spacer forms a gap S1 that allows a sheet P to pass between the lower face of the main frame 70 and an upper face 27a of the leg 27.

As shown in FIG. 10, the main frame 70 is provided with eight upper and lower punch supporting holes 28 in total formed so as to penetrate through the upper and lower faces of the main frame 70. The punches 89a, 89b, 89c and 89d are slidably and fittingly inserted into these punch-supporting holes 28, respectively. Four dies 29 are formed on the upper face 27a of the leg 27 so as to face to the punch supporting holes 28 at the lower face of the main frame 70. The punches 89a through 89d are arrayed at an equal pitch (D3) and compose the first group for punching four holes and the second group for punching two holes.

Then, the punch 89d for example is provided with a through hole 10 perforated in the direction orthogonal to its moving direction (vertical direction in the figure). The through hole 10 supports the pin 25 so that the pin 25 penetrates through the hole 10 and the second linear portion 14b of the cam plate 75 and protrudes toward a guide long hole 26 formed in the vertical direction of the main frame 70. The guide long hole 26 is formed so as to penetrate through a side wall of the main frame 70 and so that its longitudinal direction orients in the vertical direction. Removable stop rings not shown are fitted to the both ends of the pin 25.

Still more, the punch 89d is provided with a spring not shown that biases the punch 89d toward the corresponding die 29 and that is interposed between the upper edge of the main frame 70 and the stop ring fixed to the punch 89d. Although the spring biases the punch 89d downward, the punch 89d will not come out of the main frame 70 because the pin 25 penetrates through the second linear portion 14b of the cam 14 and is held by that. It is noted that although the structure for supporting the punch has been described here centering on that of the punch 89d, the structure for supporting the other punches 89a through 89c is the same with that and an explanation thereof will be omitted here.

The rack 83 is linked to the left end of the cam plate 75 in FIG. 6. This will be explained with reference also to FIG. 11. The dousing plate 9 described above extending along the longitudinal direction (lateral direction in the figure) of the cam plate 75 is linked to the back of the rack 83 (on the depth side in the figure). A link plate 8 is linked to the left end of the main frame 70 by a fixing screw 3. The movable range detecting sensor 76, 77 and 78 described above are sequentially disposed on the link plate 8 at a predetermined pitch. The movable range detecting sensor 78 may be omitted by disposing a stopper 23 described later in the present embodiment.

A slide guide 4 for suppressing looseness of the rack 83 during its move is linked to an extension 70a of the main frame 70 extending in the left direction in the figure. The slide guide 4 is made of a synthetic resin material for example and the stopper (move restricting means) 23 described above may be provided at an adequate position of its slide groove not shown.

The stopper 23 may be formed in a body with the slide guide 4 by the same synthetic resin material and concurrently in fabricating the slide guide 4. For instance, it may be provided at the position facing to the left end of the rack 83 in the state in which the cam plate 75 is moved in the right direction in FIG. 6 to the second movable range R2.

At this time, although the cam plate 75 is capable of reciprocate within the second movable range R2 in the state in which its left side in the figure is restricted by the-stopper 23, the cam plate 75 will not be switched to the first movable range R4 during its operation in the second movable range R2 even if it becomes difficult to discriminate rotational position of the motor by the encoder 2 due to a system-down such as a power failure and the cam plate 75 is tried to be moved to the first movable range R4 in the left direction in the figure because the stopper 23 reliably stops its move. That is, the simple arrangement using such stopper 23 allows the movable range detecting sensor 78 described above to be omitted.

As shown in FIG. 11, the dousing members 5, 6 and 7 described above are connected at the positions of the cam plate 75 in the vicinity of the rack 83 so as to be able to sequentially face to the movable range detecting sensor 76 when the cam plate 75 moves. It is noted that the position of the movable range detecting sensor 76 and the dousing members 5, 6 and 7 in the depth direction is different from that of the movable range detecting sensors 77 and 78 and the douser 9.

In the punching unit 60 of the present embodiment having the structure described above, a range to which the cam plate 75 reaches when it is moved by one step in the right direction in the figure from the home position, i.e., the initial state in FIG. 6, is the first movable range R4 and a range to which the cam plate 75 reaches when it is moved further by one step in the right direction in the figure from the neutral position, i.e., the neutral positions caused by the second linear portions 12b and 13b, is the second movable range R2.

The four-hole punching state using the four-hole punches 89a, 89b, 89c and 89d as the first group is obtained by reciprocating the cam plate 75 within the first movable range R4 and the two-hole punching state using the two-hole punches 89b and 89c as the second group is obtained by reciprocating the cam plate 75 within the second movable range R2.

For instance, when the home position is denoted as N₁ and the position where the punches separate from the dies 29, thus producing the non-punching state beside the home position, is defined as a neutral position, neutral positions N₁ and N₂ exist, while interposing the intermediate position where the respective punching state is produced, in order from the home position N₁ in the first and second movable ranges R4 and R2 sequentially provided from the home position N₁ in the right direction in FIG. 6. With respect to the first and second movable ranges R4 and R2 existing in one direction from the N₁, this state may be expressed as follows:
N₁←→four-hole punching state (R4)←→N₂←→two-hole punching state (R2)←→N₃

(Operation in Punching Four Holes)

In the initial state (initial position) of the punching unit 60 in which the motor 73 is stopped in FIG. 6, the pin 25 of the punch 89a is positioned in the second linear portion 11b of the cam 11, the pin 25 of the punch 89b is positioned in the third linear portion 12c of the cam 12, the pin 25 of the punch 89c is positioned in the third linear portion 13c of the cam 13 and the pin 25 of the punch 89d is positioned in the second linear portion 14b of the cam 14, respectively. That is, all of the punches are held at the highest positions.

When a sheet P is fed to the gap S1 and is positioned at a predetermined position in this initial state, the control means 80 turns on the punching unit 60 similarly to the case of the punching unit 30 described above. It is assumed that a user has made a setting for punching four holes in advance by this point of time.

When the motor 73 rotates so as to shift the cam plate 75 from the initial state to the four-hole punching state, the cam plate 75 starts to move in the right direction in FIG. 6 and guides the respective pins 25 of the punches 89a through 89d to the bottom of the V-shaped portions 15, 17, 19 and 22 of the corresponding cams 11 through 14, respectively. Thereby, all of the punches 89a through 89d, as the first group, drop to the lowest position, respectively, and engage with the dies 29 (see FIG. 10) after punching holes in the sheet P. In the same time, the control means 80 recognizes that four holes have been punched in the sheet P by the punches 89a through 89d of the first group based on the result detected by the movable range detecting sensors 76 and 77.

Then, because the motor 73 rotates in the same direction and the cam plate 75 moves further in the right direction within the first movable range R4, all of the punches 89a through 89d are raised to and kept at the highest position by the first linear portion 11a, the second linear portion 12b, the second linear portion 13b and the first linear portion 14a, each corresponding to the cams 11 through 14. At this time, the sheet P in which the four holes have been punched is pulled out of the gap S1 and a new sheet P is fed to the gap S1.

When the motor 73 rotates reversely by a predetermined number of revolutions in this state and when the cam plate 75 moves in the left direction in the figure, four holes are punched in the new sheet P by the four-hole punches 89a through 89d. When the cam plate 75 moves further in the left direction, the respective pins 62 of the punches 89a through 89d are led to the second linear portion 11b, the third linear portion 12c, the third linear portion 13c and the second linear portion 14b, respectively, and the cam plate 75 returns to the initial state.

(Operation in Punching Two Holes)

When a sheet P is fed to the gap S1 and is stopped at the predetermined position in the state in which the punches 89a through 89d are positioned at the first linear portion 11a, the second linear portion 12b, the second linear portion 13b and the first linear portion 14a, each corresponding to the cams 11 through 14, and are kept at the highest position and when the motor 73 is stopped, the control means 80 turns on the punching unit 60. It is assumed that the user has made a setting for punching two holes in advance by this point of time.

Then, when the motor 73 rotates so as to shift the cam plate 75 from the state described above to the two-hole punching state, the cam plate 75 starts to move in the right direction in FIG. 6 and the pins 25 of the punches 89a and 89d not used in punching two holes are held as they are at the highest position by the first linear portion 11a and the first linear portion 14a. In contrary to that, the pins 25 of the punches 89b and 89c which are also used in punching two holes similarly to the case of punching four holes are guided from the second linear portion 12b to the bottom of the V-shaped portion 16 and from the second linear portion 13b to the bottom of the V-shaped portion 18, respectively. Thereby, the two-hole punches 89b and 89c drop to the lowest position (punching position), respectively, and engage with the dies 29 after punching holes in the sheet P. At this time, based on the result detected by the movable range detecting means 77, the control means 80 recognizes that two holes have been made in the sheet P by the punches 89b and 89c of the second group.

Then, in response to a signal from the control means 80, the motor 73 rotates in the same direction and moves the cam plate 75 further in the right direction within the second movable range R2, so that all of the punches 89a through 89d are held at the highest position by the first linear portion 11a, the second linear portion 12a, the second linear portion 13a and the first linear portion 14a each corresponding to the cams 11 through 14. At this point of time, the sheet P in which the two holes have been punched is pulled out of the gap S1 and a new sheet P is fed to the gap S1. When the motor 73 rotates reversely by a predetermined number of revolutions in this state and when the cam plate 75 moves in the left direction in the figure, two holes are punched in the new sheet P by the two-hole punches 89b and 89c.

As described above, the punching unit 60 of the present embodiment brings about the following effects in addition to the similar effects of the first embodiment.

That is, the punching unit 60 enables the cam plate 75 to readily and reliably reach to the first movable range R4 or the second movable range R2 just by advancing the cam plate 75 in one direction by one step from the home position N₂ or by advancing it in the same direction further by one step from the first movable range R4. Accordingly, the control may be simplified. Still more, it is capable of vertically moving the punches 89a through 89d reliably as the first or second group just by reciprocating the cam plate 75 within the first and second movable range R4 and R2.

Still more, because the first group is composed of the four punches, i.e., an even number of punches, and the second group is composed of the two center punches 89b and 89c among the punches 89a through 89d of the first group, the four- and two-hole punching processes may be adequately and freely carried out on the sheet P (it is of course possible to punch an even number of holes of more than four) without shifting, in correspondence to each process, the center of each punching state of the four-punching state which is carried out centering on the center part of the four punches 89a through 89d, i.e., the middle position between the punches 89b and 89c, of the first group and of the two-hole punching state which is carried out centering on the middle position between the two center punches 89b and 89c of the first group.

It is also possible to omit the movable range detecting sensor 78 for detecting the move of the cam plate 75 by the very simple arrangement of just restricting the move of the cam plate 75 to the opposite movable range by the stopper 23. That is, when the punching unit 60 is mounted to a copying machine or the like, a control is made so as to be able to use only the group actually used often based on the movable range detecting sensor 78 that detects the move the cam plate 75 to the opposite group. For instance, when the control is reset after when a supply of electric power is started again from a condition of system-down such as a power failure, the control of shifting the cam plate 75 to the group used before the power failure is normally carried out based on the result detected by the movable range detecting sensor 78. Accordingly, although the movable range detecting sensor 78 is essential, the stopper 23 is capable of restricting the very move of the cam plate 75 to the opposite side and the sensor 78 may be omitted in the present embodiment. Thereby, it becomes possible to reduce the product cost by omitting the relatively expensive sensor 78. That is, it enables to cut the cost required for a control board not shown in the control means 80, in addition to the cost of the movable range detecting sensor 78 itself. It also enables a considerable cost-down to be counted on in producing several tens of thousands of sets, troubles that may be otherwise caused by the sensors and the control to be reduced and its maintenance to be reduced.

Still more, the move of the rack 83 in the left direction in FIG. 6 maybe reliably restricted at certain position by providing the stopper 23 by blocking, by synthetic resin material, an adequate position of the slide groove of the slide guide 4 made of synthetic resin. Or, instead of that, it is possible to restrict the move of the rack 83 in the right direction of the figure from the certain position and the same effect with that described above may be obtained by fixing a member made of an adequate material, e.g., a metallic screw, at an adequate position corresponding to the right end of the cam plate 75 in the main frame 70.

When the stopper 23 is formed in the slide groove of the slide guide 4, only the cost for correcting a die of the slide guide 4 needs to be taken into account and hence it may be handled at very low cost without increasing the cost.

It may be needless to say that the arrangement of eliminating the movable range detecting sensor 78 by providing the stopper 23 is also applicable to the first embodiment described above.

### INDUSTRIAL APPLICABILITY

As described above, the inventive punching unit is useful as what is mounted to a main body of an image forming apparatus such as a copying machine, a printer, a facsimile and a multifunction machine of those machines or to a printing machine, and is specifically suitable to an apparatus which is required to be simplified by reducing a number of parts.

1. A punching unit, comprising a plurality of punches and dies for punching holes in a sheet type member to be punched, a reciprocating member capable of reciprocating in a direction orthogonal to a moving direction of said punches, and a plurality of cams and followers engaging with said cams, interposed between said reciprocating member and said plurality of punches, for converting the reciprocating movement of said reciprocating member to a vertical movement of said punches to punching and non-punching positions; wherein
said plurality of punches are grouped into a first group composed of a predetermined number of punches and into a second group containing any one of the punches of said first group and having a less number of punches than the predetermined number of punches of said first group; and
a punching state of the predetermined number of punches is produced by reciprocating said reciprocating member within a first movable range and by vertically moving the punches of the said first group through an intermediary of said cams and followers corresponding to the punches of said first group and a punching state of the less number of punches than the predetermined number of punches is produced by reciprocating said reciprocating member within a second movable range and by vertically moving the punches of said second group through an intermediary of said cams and followers corresponding to the punches of said second group.

2. The punching unit as set forth in claim 1, wherein said first movable range is a range to which said reciprocating member reaches in advancing in one direction from a home position with respect to a main frame and said second movable range is a range to which said reciprocating member reaches in advancing in the other direction from the home position.

3. The punching unit as set forth in claim 2, wherein first and second neutral positions are provided on the opposite side from the home position respectively in said first and second movable ranges at the positions interposing the home position therebetween; and
said reciprocating member vertically moves said plurality of punches as said first group or as said second group in reciprocating in said first or second movable range.

4. The punching unit as set forth in claim 1, wherein said first group is composed of three punches arrayed at a predetermined pitch and a common punch in said first group that may be commonly used also in said second group is positioned at the center among said three punches; and
said second group is composed of said common punch and a punch dedicated for punching two holes and disposed between the punch positioned at one end among said three punches and said common punch.

5. The punching unit as set forth in claim 4, wherein said cam corresponding to said common punch is provided with, continuously via a linear portion, a first V-shaped portion capable of moving said common punch from the non-punching position to the punching position when said reciprocating member moves in one direction and a second V-shaped portion capable of moving said common punch from the non-punching position to the punching position when said reciprocating member moves in the other direction.

6. The punching unit as set forth in claim 1, wherein said first movable range is a range to which said reciprocating member reaches in advancing by one step in one direction from a home position with respect to a main frame and said second movable range is a range to which said reciprocating member reaches in advancing further by one step in one direction from said first movable range.

7. The punching unit as set forth in claim 6, wherein first and second neutral positions are provided in order from said home position in said first and second movable ranges provided sequentially in said one direction from said home position; and
said reciprocating member vertically moves said plurality of punches as that of said first or said second group in reciprocating in said first or second movable range.

8. The punching unit as set forth in claim 7, wherein said first group is composed of three or more punches arrayed at a predetermined pitch; and said second group is composed of at least two punches among the punches in said first group.

9. The punching unit as set forth in claim 1, further comprising move restricting means for restricting said reciprocating member from moving to the movable range on the opposite side in using said reciprocating member in said first or second movable range.

10. The punching unit as set forth in claim 9, wherein said move restricting means is a stopper for blocking the move of said reciprocating member at a predetermined position with respect to said main frame.

11. The punching unit as set forth in claim 2, wherein said first group is composed of three punches arrayed at a predetermined pitch and a common punch in said first group that may be commonly used also in said second group is positioned at the center among said three punches; and
said second group is composed of said common punch and a punch dedicated for punching two holes and disposed between the punch positioned at one end among said three punches and said common punch.

12. The punching unit as set forth in claim 3, wherein said first group is composed of three punches arrayed at a predetermined pitch and a common punch in said first group that may be commonly used also in said second group is positioned at the center among said three punches; and
said second group is composed of said common punch and a punch dedicated for punching two holes and disposed between the punch positioned at one end among said three punches and said common punch.

13. The punching unit as set forth in claim 11, wherein said cam corresponding to said common punch is provided with, continuously via a linear portion, a first V-shaped portion capable of moving said common punch from the non-punching position to the punching position when said reciprocating member moves in one direction and a second V-shaped portion capable of moving said common punch from the non-punching position to the punching position when said reciprocating member moves in the other direction.

14. The punching unit as set forth in claim 12, wherein said cam corresponding to said common punch is provided with, continuously via a linear portion, a first V-shaped portion capable of moving said common punch from the non-punching position to the punching position when said reciprocating member moves in one direction and a second V-shaped portion capable of moving said common punch from the non-punching position to the punching position when said reciprocating member moves in the other direction.
